(19) United States
(12) Patent Application Publication
(10) Pub. No.: US 2012/0129669 A1
(43) Pub. Date: May 24, 2012

(54) COMPOSITE MATERIAL ROLLER

(76) Inventors: Hiroshi Aoyama, Tsuchiura (JP); Takahiko Sawada, Hitachinaka (JP)

(21) Appl. No.: 13/383,778

(22) PCT Filed: Feb. 22, 2010
(86) PCT No.: PCT/JP2010/052660

§ 371 Date: Jan. 26, 2012

(30) Foreign Application Priority Data
Aug. 12, 2009 (JP) 2009-186968

(51) Int. Cl. F16C 13/00; B32B 1/04

(52) U.S. Cl. 492/47; 428/414

(57) ABSTRACT

A composite material roller that itself rotates comprises a cylindrical laminate 1 of fiber-knitted cloths 2 impregnated with resin; and a sheet 4, formed of a fiber different from that of the laminate 1, for covering the rotary surface of the laminate 1. The longitudinal elastic modulus of the fiber in the cloths 2 is made lower than that of the resin in the cloths 2. Also, the rigidity of the fiber in the cloths 2 is made lower than that of the resin in cloths 2. The above configuration reduces the contract pressure between the composite material roller and a structure on which the roller slides.

### TECHNICAL FIELD

The present invention relates to cylindrical rollers that are formed of composite materials and allowed to rotate.

### BACKGROUND ART

Reducing the weight of a structure often involves replacing some of its materials with materials of superior strength and reducing component thickness.

The same goes for the weight reduction of the ladder of a fire track or the boom of a cherry picker; they are typically designed to be thinner, but strong enough. Such a ladder or boom includes multiple similar structures formed by welding square steel pipes together, and these structures are designed to make telescopic movements. Typically, to smooth such movements, slide members or rollers are provided between the structures. These rollers are often made of alloy steel so that they can withstand high heat and have high compressive strength. JP-04-286633-A, in contrast, discloses a resin roller although it is not intended for large structures such as ladder trucks or cherry pickers. This roller is such that its core is made of a thermosetting resin reinforced with carbon fiber, and the outer surface of the core is plated with gold.

### PRIOR ART LITERATURE

### Patent Document

Patent Document 1: JP-04-286633-A

### SUMMARY OF THE INVENTION

### Problem to be Solved by the Invention

In reducing the weight of the ladder of a ladder truck or the boom of a cherry picker, the following problems are encountered with conventional techniques. After the structures of the ladder or the boom have been decreased in thickness, the rollers provided between the structures may apply compressive force locally during the telescopic movement of the structures, thus causing deformation of the structures. To prevent the rollers from causing concave deformations, therefore, the structures cannot be reduced too much in thickness, which often results in the total weight not decreasing much. Alternatively, to prevent the rollers from causing concave deformations, it is necessary to make the rigidity of the rollers smaller than that of alloy steel rollers, thereby reducing the maximum compressive stress applied to roller contact portions. However, even if the resin roller of JP-04-286633-A is applied to a ladder truck or cherry picker, the rigidity of the roller is still high due to the reinforcement of the resin with carbon fiber, not leading to reduction in the contact pressure between the roller and roller contact portions.

An object of the present invention is thus to provide a composite material roller that reduces the contact pressure between the roller and roller contact portions.

### Means for Solving the Problem

To solve the above problems, the present invention is a composite material roller that itself rotates comprising: a cylindrical laminate of fiber-knitted cloths impregnated with resin; and a sheet, formed of a fiber different from the fiber of the laminate, for covering the rotary surface of the laminate. Preferably, the longitudinal elastic modulus of the fiber in the cloths is lower than the longitudinal elastic modulus of the resin in the cloths. Also, the rigidity of the fiber in the cloths is lower than the rigidity of the resin in cloths. It is also preferred that the fiber of the sheet be an organic fiber. Circular metal plates are attached to the surfaces other than the rotary surface of the laminate, the circular metal plates each having an outer circumference smaller than the outer circumference of the laminate. In addition, the composite material roller further comprises a shaft member made of a resin material reinforced with an organic fiber or of graphite, and an area around the central axis of the laminate is machined to allow the area to act as a female screw. The shaft member is screwed into and fastened by the female screw. It is further preferred that the sheet be tape whose width is equal to or less than the full width of the rotary surface of the laminate and that the tape be wrapped around the rotary surface of the laminate multiple times. Furthermore, grooves are formed on the rotary surface of the laminate such that the grooves extend from a widthwise central area of the rotary surface to the end sections of the laminate.

### Effect of the Invention

In accordance with the present invention, it is possible to provide a composite material roller that reduces the contact pressure between the roller and roller contact portions.

### BRIEF DESCRIPTION OF THE DRAWINGS

FIG. 1 is a perspective view of a composite material roller;

FIG. 2 is a perspective view of the composite material roller and a cloth laminate;

FIG. 3 is a perspective view of a cloth wrapped around a shaft as the base material of a roller;

FIG. 4 shows the distribution of stress across a roller contact member;

FIG. 5 illustrates changes in the frictional coefficient of organic fiber;

FIG. 6 is a perspective view of a composite material roller having protector plates attached to both of its end surfaces;

FIG. 7 is a perspective view of a composite material roller with a shaft member;

FIG. 8 is a perspective view of a device for coiling fiber around a roller core;

FIG. 9 is a perspective view of a device for coiling fiber tape around a roller core;

FIG. 10 is a perspective view of a composite material roller with grooves;

FIG. 11 is a perspective view of a roller molding device;

FIG. 12 is a perspective view of a fire ladder truck;

FIG. 13 is a perspective view of the roller section located at the end of a ladder section of a ladder truck; and

FIG. 14 is a perspective view of a cherry picker.

### MODE FOR CARRYING OUT THE INVENTION

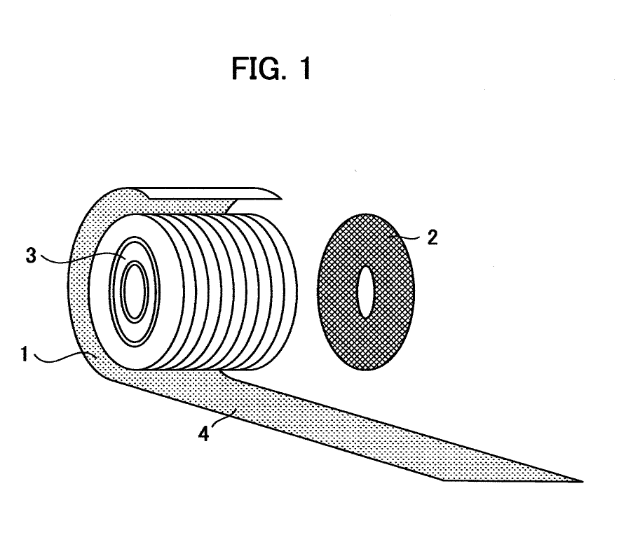

Embodiment 1 of the present invention will now be described with reference to FIG. 1 through 5.

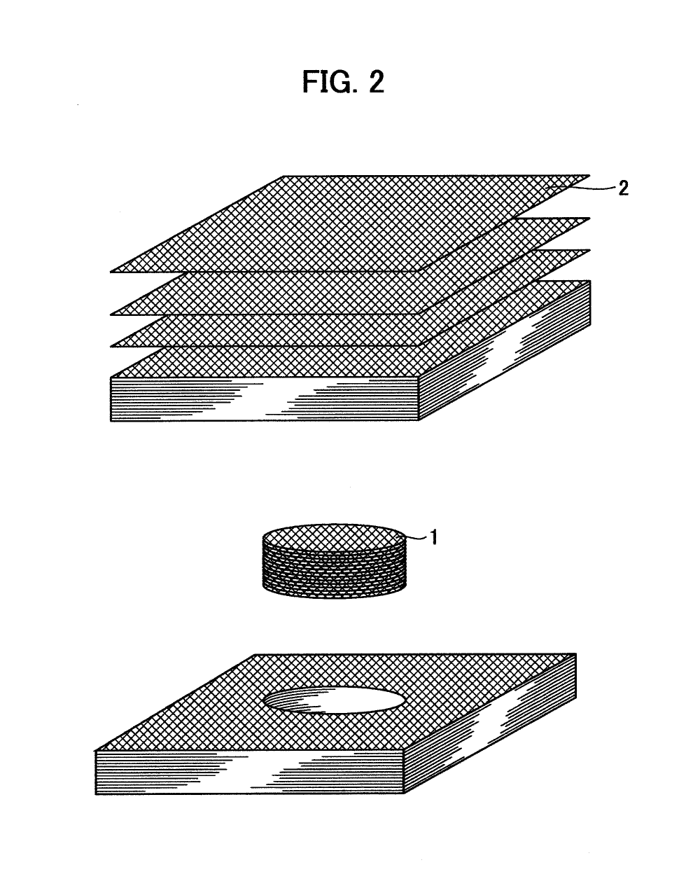

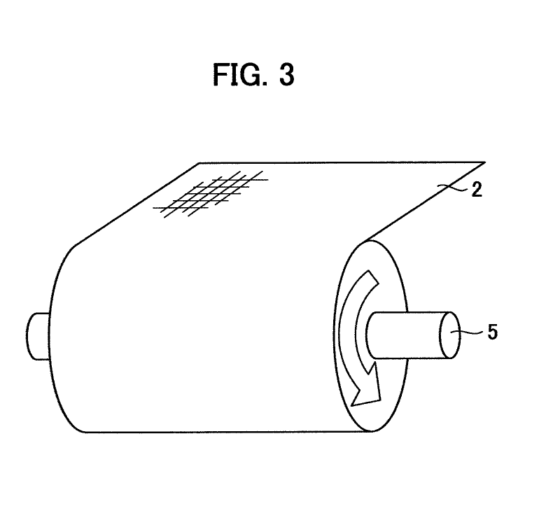

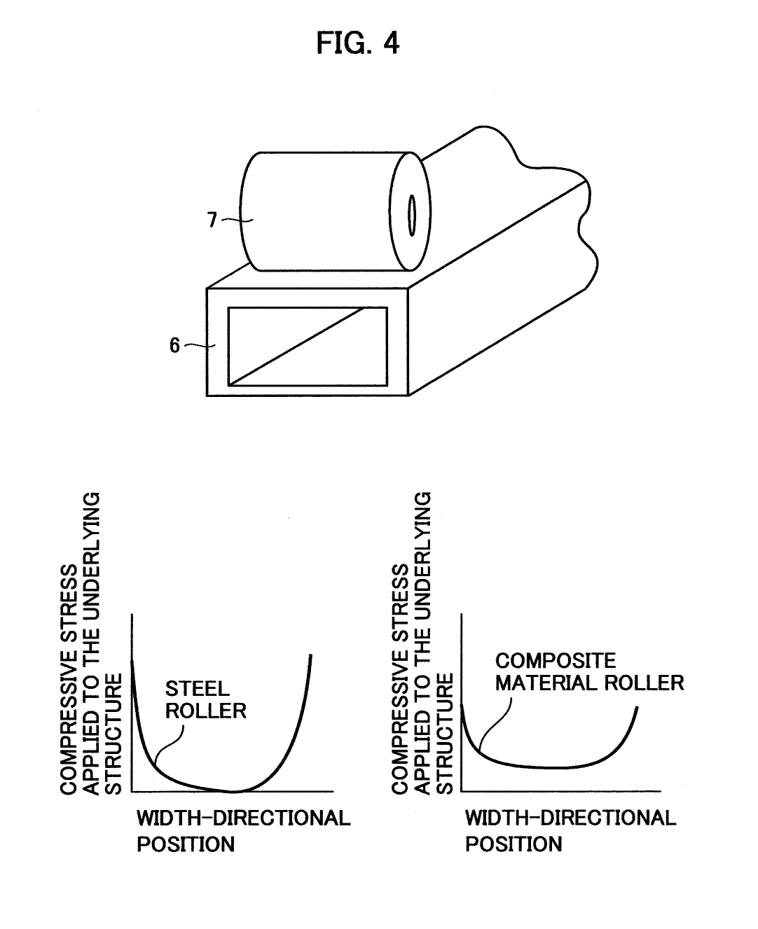

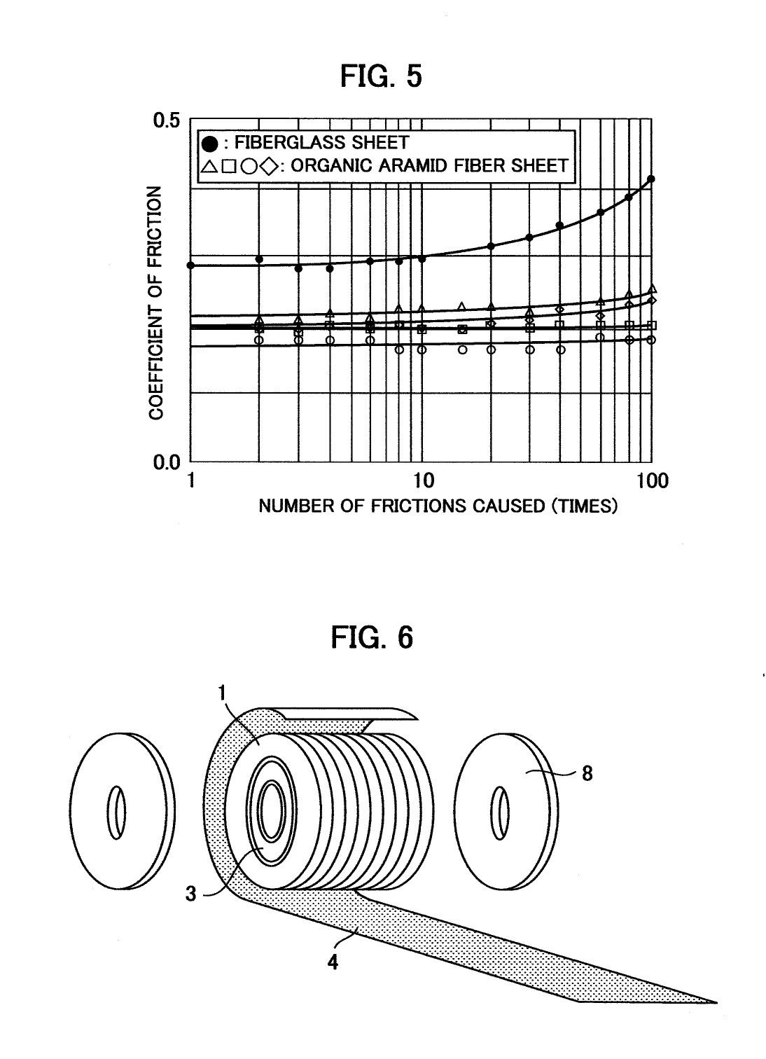

FIG. 1 is a perspective view of a composite material roller. FIG. 2 is a perspective view of the composite material roller and a cloth laminate. FIG. 3 is a perspective view of a cloth wrapped around a shaft as the base material of a roller. FIG. 4 shows the distribution of stress across a roller contact member. FIG. 5 illustrates changes in the frictional coefficient of organic fiber.

Referring to FIG. 1, a roller core 1 is formed by impregnating cotton cloths 2 with phenolic resin, stacking the resultant cloths 2, and then machining the laminate into a cylindrical shape. The resin-impregnated cloths 2 are stacked in a direction perpendicular to the axis of the roller core 1.

Referring to FIG. 2, a machine press is used to press the laminate of the resin-impregnated cloths 2 from a direction perpendicular to the cloths 2. At the same time, the cloth laminate is heated to harden the phenolic resin. The roller core 1 is then cut out from the laminate by machining. The area surrounding the central axis of the roller core 1 is subjected to machining so that a bearing 3 can fit in it. The radially outer surface of the roller core 1 (i.e., its rotary surface) is wrapped in a sheet 4 that is formed by mixing aramid fiber with resin. During the wrapping process, epoxy resin is used to glue the sheet 4 to the roller core 1. The sheet 4 is made of organic fiber (aramid fiber) and wrapped around the roller core 1 once or several times so that the radially outer surface of the roller core 1 can be completely covered with the sheet 4. A fiber other than cotton fiber can also be used to form the roller core 1; examples include polymeric fibers such as nylon fiber, polyester fiber, silk fiber, wool fiber, and wood fiber. In addition, the resin with which to impregnate the cloths 2 may be a resin other than phenolic resin; examples include epoxy resin, nylon resin, polyester resin, polycarbonate resin, and fluorine resin. Whatever the material, the longitudinal elastic modulus of the fiber in the cloths 2 should be equal to or less than that of the resin in the cloths 2. Moreover, the rigidity of the fiber in the cloths 2 should be equal to or less than that of the resin in the cloths 2. Such material selection prevents the rigidity of the roller core 1 from becoming excessively higher than the rigidity of the resin. It also allows easy formation of a thick roller core since the resin-impregnated cloths 2 are used to form the core. When the roller core 1 is instead formed by pouring resin into a mold, the resin may not be cooled uniformly, often resulting in cracks due to residual stress.

FIG. 3 illustrates how to make a typical phenolic roller. This roller is formed by impregnating a cloth 2 with half-cured phenolic resin, wrapping the resultant cloth 2 around a shaft 5, and then heating the cloth 2 to harden the resin. With this method, small air bubbles may get struck between the wrapped cloth layers. Such bubbles could trigger cracks, dramatically reducing the roller's rigidity.

In Embodiment 1, by contrast, the cloths 2 impregnated with phenolic resin are stacked, and during the heating of the clothes 2, a press is used to apply a high compressive force to the cloths 2. This allows air bubbles inside to be forced out, making it difficult for cracks to occur. It is thus possible to form a thick, rigid phenolic-resin plate (laminate). Then, from this resin plate, a roller core that has the same diameter as that of the roller core 1 is cut out by machining, whereby a rigid roller can be obtained.

FIG. 4 illustrates the distributions of compressive stress across an underlying structure 6 on which a roller 7 slides. When the roller 7 is made of alloy steel, the ends of the roller 7 apply high compressive stresses to the underlying structure 6, and these high compressive stresses will cause a concave deformation of the underlying structure 6. When, on the other hand, the composite material roller of Embodiment 1 is used as the roller 7, the ends of the roller can change their own shapes to some extent due to the resin's low rigidity, thereby applying lower compressive stresses to the underlying structure 6. Also, the widthwise central area of the roller 7 receives a larger stress; consequently, the distribution of compressive stress becomes flatter. Therefore, Embodiment 1 can reduce the maximum compressive stress applied to the underlying structure 6 when the roller 7 is in contact. This makes it possible to reduce the thickness and mass of the underlying structure 6. In addition, the use of phenolic resin leads to a highly fire-resistant roller. Furthermore, since the roller core 1 is machined, it is possible to provide a roller of accurate dimensions, regardless of dimensional changes which occur during resin curing. Also, the machining process can be completed in a speedy manner because easy-to-cut cotton is used as the base material of the roller core 1.

FIG. 5 is a graph showing changes in the frictional coefficient of the sheet 4 (as already stated, the sheet 4 is glued to the radially outer surface of the roller core 1 and formed by mixing aramid fiber with resin). In the case of a conventional sheet formed by cutting fiberglass-reinforced resin, an increase in the number of frictions will raise the frictional coefficient of that sheet. When such a fiberglass sheet is used, the fracture strength of the roller core 1 will eventually be reached, resulting in a fracture of the roller. In contrast, the frictional coefficient of the organic fiber sheet 4 of Embodiment 1 is stable as demonstrated by several test results. It is stable even when the roller rotates a number of times; thus, the roller is prevented from being destroyed.

Embodiment 2 of the invention will now be described. FIG. 6 is a perspective view of a composite material roller. In this embodiment, protector plates 8 are attached to both ends of a roller core 1, which is formed by cutting a laminate of resin-impregnated cloths. In other words, the protector plates 8 are attached to the surfaces other than the rotary surface of the roller core 1 (i.e., to the lateral surfaces of the roller core 1). The protector plates 8 are machined to have a smaller outer circumference than that of the roller core 1 and made of metal or FRP (fiber-reinforced plastic). Embodiment 2 is designed to prevent cloths from coming off the ends of the roller even after a long period of use. In addition, since the protector plates 8 have a smaller outer circumference than that of the roller core 1, they will neither come into contact with the underlying structure 6 during rotation nor damage the underlying structure 6.

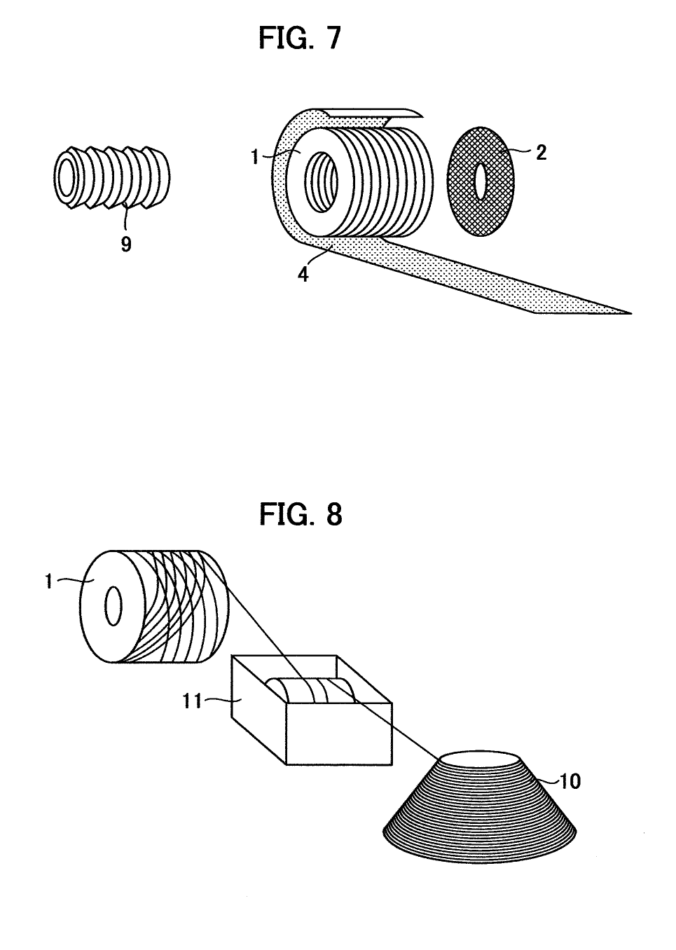

Embodiment 3 of the invention is described next. FIG. 7 is a perspective view of a composite material roller. In this embodiment, an area around the axis of a roller core 1, which is formed by cutting a laminate of resin-impregnated cloths, is machined to allow the area to act as a female screw. A shaft member 9 is separately fabricated to fit in the female screw and then screwed into it. The shaft member 9 is made of a composite material reinforced with organic fiber or of graphite. Before the shaft member 9 is screwed into the female screw, an adhesive is applied to the screw so that the shaft member 9 will not become loose during use. Because the frictional force exerted on the shaft member 9 is stable during roller rotation, Embodiment 3 can eliminate the need for a bearing 3, which is fixed to the roller cores 1 of the previous embodiments. Also, the shaft member 9 is lighter than the bearing 3; thus, it is possible to reduce the total weight of a structure that incorporates the composite material rollers of Embodiment 3.

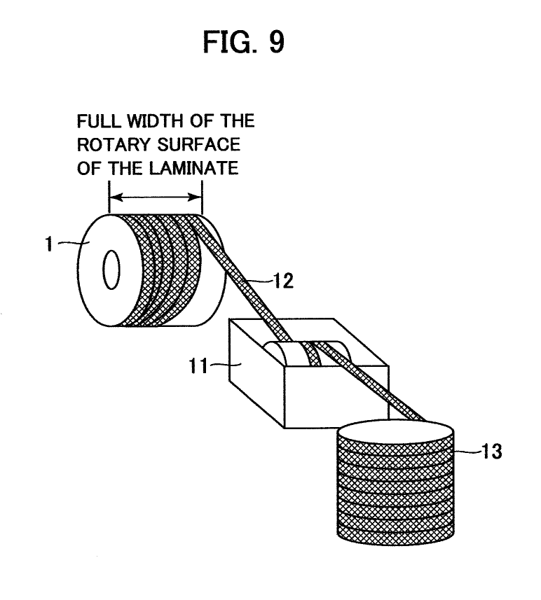

Embodiment 4 of the invention is described next. FIG. 8 is a perspective view of a device for coiling fiber around a roller core 1 whereas FIG. 9 is a perspective view of a device for coiling fiber tape around a roller core 1. As illustrated in FIG. 8, yarn 10 (a fiber made by bundling glass fiber, carbon fiber, and organic aramid fiber) is coiled around a roller core 1 after the yarn 10 has been dipped in a resin tank 11 filled with half-cured epoxy resin. As with the previous embodiments, the roller core 1 of FIG. 8 is formed by impregnating fiber-knitted cloths 2 with resin, stacking the resultant cloths 2, heating the laminate while applying a pressure to it to harden the resin, and then machining the laminate into a cylindrical shape. After the yarn 10 has been coiled around the roller core 1, the roller core 1 is hardened by heating, thereby obtaining a roller. In FIG. 9, by contrast, constant-width tape 12 (fiber tape made by knitting, using glass fiber, carbon fiber, and organic aramid fiber) is uncoiled from a tape roll 13 and then coiled around a roller core 1 after the tape 12 has been dipped in a resin tank 11 filled with half-cured epoxy resin. The roller core 1 of FIG. 9 is formed in the same manner as in the other embodiments. What differs between FIG. 9 and Embodiment 1 is that, in FIG. 9, the tape 12 is used in place of the sheet 4. After the tape 12 has been coiled around the roller core 1, the roller core 1 is hardened by heating, thereby obtaining a roller. The tape 12 has a width equal to or less than the full width of the rotary surface of the roller core 1 (the cloth laminate). In Embodiment 4, fiber or fabric is coiled around the radially outer surface of the roller core 1 as described above, without producing uneven levels across the width of the rotary surface of the roller core 1. Thus, it is possible to prevent the roller from oscillating due to such uneven levels during rotation of the roller, thereby reducing noise. It is also possible to prevent a resin roller from being damaged by the impact due to uneven levels.

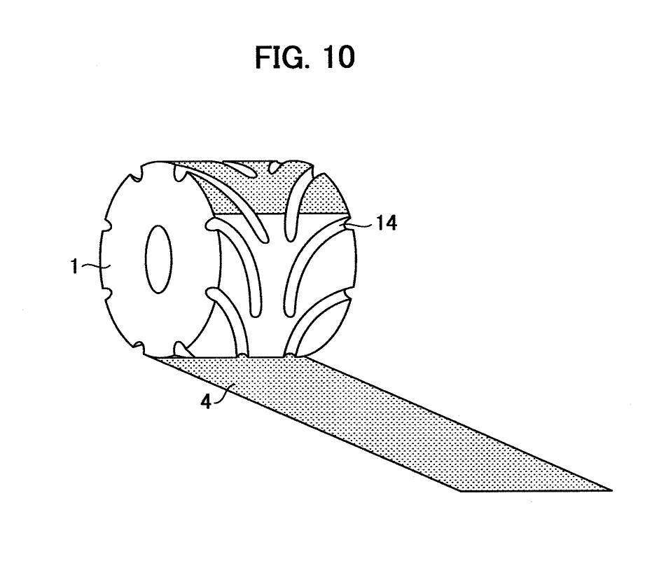

Embodiment 5 of the invention is described next. FIG. 10 is a perspective view of a composite material roller. In this embodiment, the roller has grooves 14 on its radially outer surface. The grooves 14 can be cut after an organic-fiber reinforced resin sheet 4 has been wrapped around the roller core 1. Alternatively, it is also possible to cut the grooves 14 after the roller core 1 has been made and then glue the sheet 4 to the roller core 1 such that the sheet 4 fits along the grooves 14. The grooves 14 are formed such that they extend continuously from a widthwise central area of the roller to its end surfaces. Without the grooves 14, foreign substances, water, or oil may be caught between the roller and the underlying structure 6 during roller rotation, which may locally thrust the roller upward or drastically change the frictional force between the roller and the underlying structure 6. Embodiment 5, by contrast, allows foreign substances, water, or oil to enter the grooves 14, whereby such substances can be forced out from the roller end surfaces to the outside. Therefore, even if exposed to dirt or rain, the roller will not be damaged, which allows extension of the roller's life.

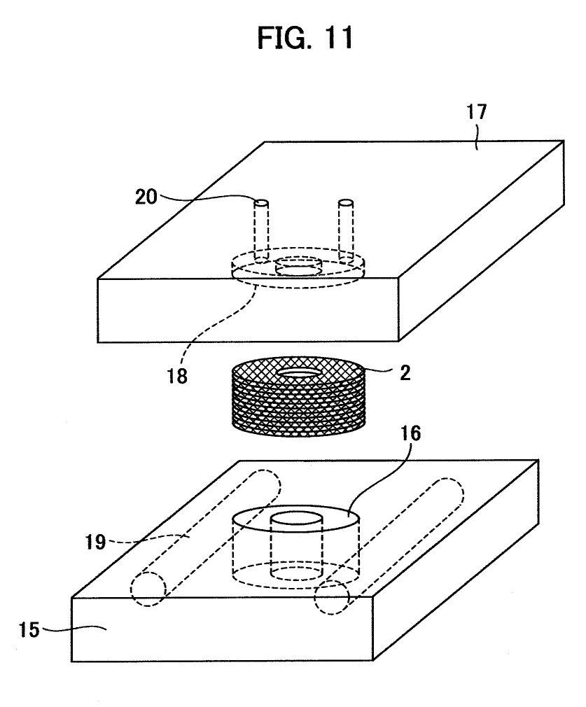

Embodiment 6 of the invention is described next. FIG. 11 is a perspective view of a roller molding device. In this embodiment, cotton-knitted cloths 2 are first impregnated with phenolic resin and then each cut to have the same outer circumference as that of a roller core 1. The cut cloths 2 are put into the hole 16 of a lower mold 15 in a stacked manner. Next, the stacked cloths 2 are pressed from above with the use of an upper mold 17 having a convex portion 18 that fits in the hole 16. Located inside the lower mold 15 are heaters 19, so that the pressing can be conducted at the same time as heating, the latter of which can be done by applying electric current to the heaters 19. During the pressing/heating, extra resin is discharged through the holes 20 of the upper mold 17 to the outside in the form of liquid.

Thus, in Embodiment 6, the roller is fabricated by the following steps: 1) impregnating fiber-knitted cloths 2 with resin, stacking the resultant cloths 2, and then cutting the cloth laminate into a cylindrical shape; 2) cutting a hole near the center of the laminate; 3) putting the laminate into the hole 16 of the lower mold 15 having the heaters 19 (the hole 16 has a larger diameter than that of the laminate); 4) connecting the lower mold 15 and the upper mold 17 together, the latter of which has the convex portion 18 that fits in the hole 16 and the holes 20 open to the outside, thereby pressing the laminate from above; and 5) almost at the same time as the pressing, applying electric current to the heaters 19 to heat the lower mold 15.

In Embodiment 6, the composite material roller core 1 does not need to be cut by machining. This allows rollers of the same type to be mass-produced at high speed.

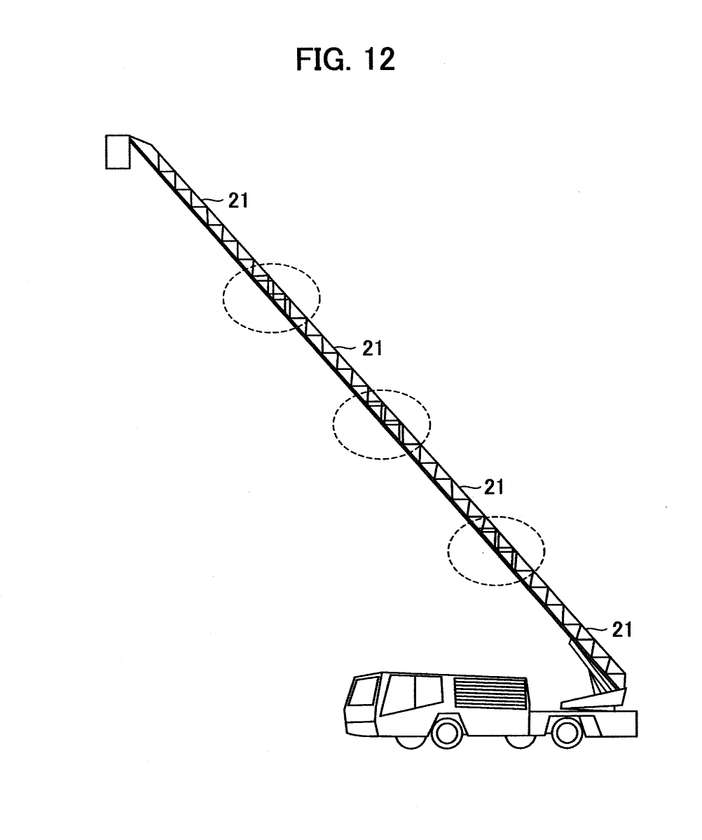

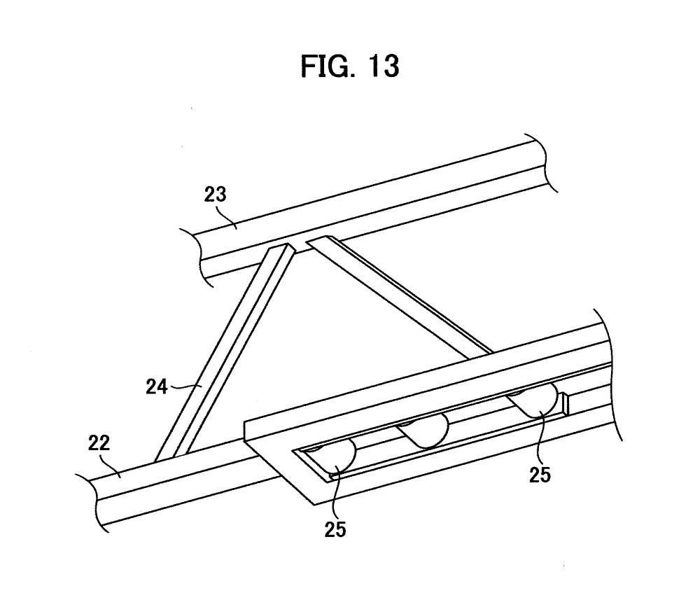

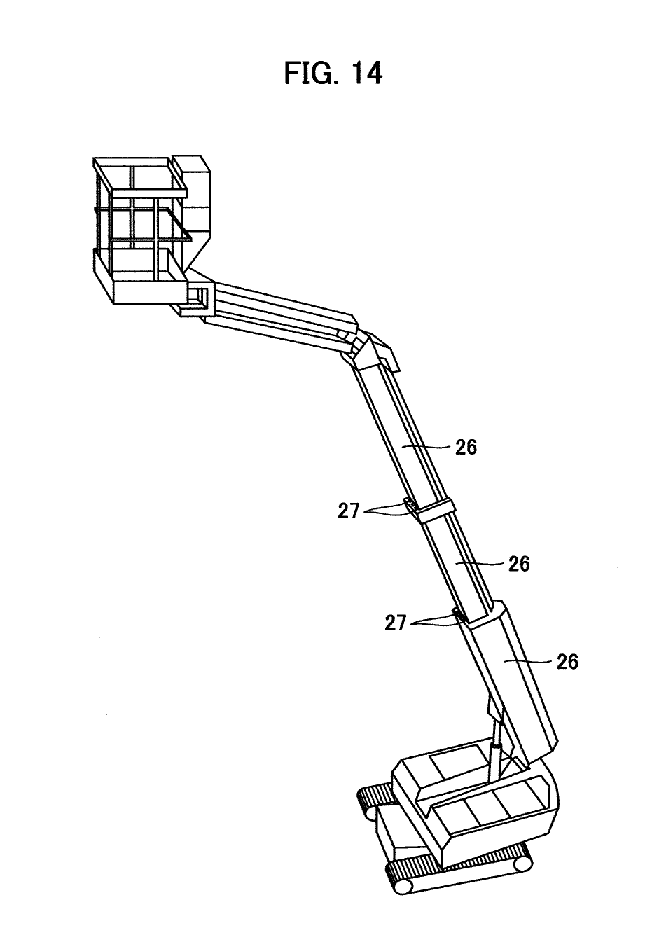

Finally, Embodiment 7 of the invention is described. FIG. 12 is a perspective view of a fire ladder truck, and FIG. 13 a perspective view of the roller section located at the end of a ladder section of the truck. FIG. 14 is a perspective view of a cherry picker. The ladder truck of FIG. 12 has four ladder sections 21, and FIG. 13 illustrates in detail the overlapping section between two ladder sections 21. The ladder sections 21 are each formed by welding together three types of square steel pipes: lower frames 22, upper frames 23, and oblique frames 24. The lower frames 22 are designed to slide on end rollers 25 that rotate. In this embodiment, the end rollers 25 may be any of the composite material rollers of Embodiments 1 to 6. Typically, the end rollers 25 are steel cylinders. In that case, the maximum compressive stress applied by the end rollers 25 to the lower frames 22 may occasionally reach the yield point of the steel used in the lower frames 22. If the ladder continues to be used beyond the yield point, the lower steel plates of the lower frames 22 may begin to deform. To prevent this, what is typically done is to increase the plate thickness of the square steel pipes that constitute the lower frames 22. This, however, results in heavy ladder sections 21, not leading to weight reduction. In Embodiment 7, by contrast, the maximum compressive stress applied by the end rollers 25 to the lower steel plates of the lower frames 22 can be reduced; thus, the thickness of those lower plates can also be reduced. Because each of the lower frames 22 can be made thinner across its entire length, it is possible to reduce the total weight of the ladder truck by 20% or more. In addition, the use of phenolic resin for the cores of the composite material rollers leads to a fire truck with ladders that will not break even at a high-temperature environment.

The cherry picker of FIG. 13 includes booms 26 that move telescopically via guide rollers 27. The booms 26 are each formed by welding steel plates in the form of a box. High compressive stress is applied to the lower plates of the booms 26 that come into contact with the guide rollers 27. In this embodiment, the guide rollers 27 may be any of the composite material rollers of Embodiments 1 to 6. Typically, the guide rollers 27 are steel cylinders. In that case, the maximum compressive stress applied by the guide rollers 27 to the booms 26 may occasionally reach the yield point of the steel used in the booms 26. If the booms 26 continue to be used beyond the yield point, the lower steel plates of the booms 26 may begin to deform. To prevent this, what is typically done is to increase the plate thickness of the square steel pipes that constitute the booms 26. This, however, results in heavy booms 26, not leading to weight reduction. In Embodiment 7, by contrast, the maximum compressive stress applied by the guide rollers 27 to the lower steel plates of the booms 26 can be reduced; thus, the thickness of those lower plates can also be reduced. Because each of the booms 26 can be made thinner across its entire length, it is possible to reduce the total weight of the cherry picker by 30% or more.

The composite material rollers of Embodiment 7 are provided with grooves 14. Without the grooves 14, foreign substances, water, or oil may be caught between the lower surfaces of the booms 26 and the guide rollers 27 during the rotation of the rollers 27, which may locally thrust the rollers 27 upward or drastically change the frictional force between the rollers 27 and the booms 26. Embodiment 7, by contrast, allows foreign substances, water, or oil to enter the grooves 14, whereby such substances can be forced out from the roller end surfaces to the outside. Therefore, even if exposed to dirt or rain, the rollers will not be damaged, which allows extension of the rollers' lives.

The use of the composite material rollers of the above-described embodiments makes it possible to provide a light-weight telescopic mechanism that allows reduction of the contact pressure between the rollers and roller contact portions so as not to cause deformation of its telescopic structures. Moreover, the above embodiments provide less rigid, but sufficiently strong rollers. In other words, while the rollers rotate on a structure, it is possible to reduce the contact pressure between the rollers and roller contact portions without breaking the rollers and also to reduce the thickness of the structure, so that the weight of the structure can also be reduced.

### DESCRIPTION OF REFERENCE NUMERALS

1: Roller core

2: Resin-impregnated cloth

4: Organic-fiber reinforced resin sheet

8: Protector plate

9: Shaft member

11: Resin tank

12: Tape

14: Groove

15: Lower mold

17: Upper mold

21: Ladder section

22: Lower frame

25: End roller

26: Boom

27: Guide roller

1. A composite material roller that itself rotates comprising:
a cylindrical laminate formed by stacking fiber-knitted and resin-impregnated cloths in an axial direction of the roller; and
a sheet, formed of a fiber different from the fiber of the cloths, for covering a rotary surface of the laminate.

2. The roller of claim 1, wherein the longitudinal elastic modulus of the fiber in the cloths is lower than the longitudinal elastic modulus of the resin in the cloths.

3. The roller of claim 1, wherein the rigidity of the fiber in the cloths is lower than the rigidity of the resin in cloths.

4. The roller of claim 1, wherein the fiber of the sheet is an organic fiber.

5. The roller of claim 1, further comprising a circular metal plate is attached to the surfaces other than the rotary surface of the laminate, the circular metal plate having an outer circumference smaller than the outer circumference of the laminate.

6. The roller of claim 1, further comprising a shaft member made of a resin material reinforced with an organic fiber or of graphite,
wherein an area around a central axis of the laminate is machined to allow the area to act as a female screw and
wherein the shaft member is screwed into and fastened by the female screw.

7. The roller of claim 1, wherein the sheet is tape whose width is equal to or less than the full width of the rotary surface of the laminate and
wherein the tape is wrapped around the rotary surface of the laminate multiple times.

8. The roller of claim 1, wherein grooves are formed on the rotary surface of the laminate such that the grooves extend from a widthwise central area of the rotary surface to end sections of the laminate.
